(19) United States
(12) Patent Application Publication
(10) Pub. No.: US 2026/0369588 A1
(43) Pub. Date: Nov. 19, 2026

(54) CATHODE, ALL-SOLID-STATE BATTERY INCLUDING THE SAME, AND METHOD FOR MANUFACTURING THE SAME

(71) Applicants: HYUNDAI MOTOR COMPANY, Seoul (KR); Kia Corporation, Seoul (KR)

(72) Inventors: So Ri LEE, Hwaseong-si (KR); Ju Young JANG, Hwaseong-si (KR); Ju Yeon LEE, Hwaseong-si (KR); Jong Jung KIM, Hwaseong-si (KR)

(73) Assignees: HYUNDAI MOTOR COMPANY, Seoul (KR); Kia Corporation, Seoul (KR)

(21) Appl. No.: 19/375,027

(22) Filed: Oct. 30, 2025

(30) Foreign Application Priority Data
May 16, 2025 (KR) 10-2025-0064205

(51) Int. Cl. H01M 4/525; H01M 4/02; H01M 4/04; H01M 4/1391; H01M 4/62; H01M 4/66; H01M 10/0562

(52) U.S. Cl. CPC H01M 4/525; H01M 4/0404; H01M 4/0407; H01M 4/1391; H01M 4/622; H01M 4/625; H01M 4/661; H01M 10/0562; H01M 2004/021; H01M 2004/028; H01M 2300/0068

(57) ABSTRACT

Disclosed are a cathode, which includes double cathode active material layers, and has binders having mutually different contents in the double cathode active material layer, and an all-solid-state battery including the same, and a method for manufacturing the cathode.

### CROSS-REFERENCE TO RELATED APPLICATION

This application claims the benefit of priority to Korean Patent Application No. 10-2025-0064205, filed in the Korean Intellectual Property Office on May 16, 2025, the entire contents of which are incorporated herein by reference in its entirety.

### TECHNICAL FIELD

The present disclosure relates to a cathode, capable of improving adhesive force while improving a power, and an all-solid-state battery including the same, and a method for manufacturing the same.

### BACKGROUND

Secondary batteries have recently seen widespread adoption across various applications, including electric vehicles and portable electronic devices. Among these, all-solid-state batteries are actively being developed to achieve higher energy density. These batteries aim to improve both safety and performance—specifically energy density and lifespan—by replacing conventional liquid electrolytes with solid electrolytes.

Despite the advantages of all-solid-state batteries, several manufacturing challenges remain, particularly during the cathode coating process. One critical issue is the migration of binder material during coating, which can lead to a reduction in adhesive strength. This weakened adhesion compromises the mechanical integrity between the cathode active material and the current collector. As a result, the interface becomes more susceptible to delamination or microstructural degradation over time, especially under repeated charge-discharge cycles. This degradation is a major contributor to the decline in long-term stability and reliability of all-solid-state batteries, limiting their practical deployment in high-performance applications.

To mitigate the loss of adhesive strength, researchers have explored increasing the binder content or using binders with inherently stronger adhesion properties. While these approaches can improve mechanical bonding, they often introduce undesirable side effects. Specifically, a higher binder concentration can increase the electrical resistance within the cathode layer, thereby reducing the overall power output and energy efficiency of the battery. To counteract this, alternative strategies have focused on enhancing ionic conductivity by incorporating solid electrolytes with smaller particle sizes or increasing their volume fraction within the electrode. However, these modifications tend to reduce the binder's effectiveness, further complicating the electrode fabrication process. The reduced adhesive force can lead to poor layer cohesion, uneven coating, and difficulties in achieving uniform thickness, all of which pose significant obstacles to scalable manufacturing. Thus, balancing mechanical stability, electrical performance, and processability remains a key challenge in the development of high-performance all-solid-state battery cathodes.

Thus, for the practical commercialization of all-solid-state batteries, there is a need for cathode development that focuses on improving both adhesive strength and power performance.

### SUMMARY

In aspects, the present disclosure provides a cathode, capable of improving the adhesive force between a base material and a composite material, minimizing a resistance between interfaces, improving ion conductivity to exhibit a power characteristic, and an all-solid-state-battery including the same.

Another aspect of the present disclosure is to provide a method for manufacturing a cathode capable of minimizing the resistance between interfaces of layers in the cathode.

To solve the problem, the present disclosure provides a cathode, an all-solid-state battery including the same, and a method for manufacturing a cathode.

More specifically, (1) The present disclosure provides a cathode including a cathode current collector, a first cathode active material layer stacked on the cathode current collector and including a first solid electrolyte, a cathode active material, and a binder, and a second cathode active material layer stacked on the first cathode active material layer and including a second solid electrolyte, a cathode active material, and a binder. In this case, a reference content by weight of the binder included in the first cathode active material layer is higher than the content of a binder included in the second cathode active material layer.

(2) The present disclosure provides a cathode, in which a content of a cathode active material included in the first cathode active material layer is higher than a cathode active material included in the second cathode active material layer, based on the sum of weights of the cathode active material and the solid electrolyte included in each of the first cathode active material layer and the second cathode active material layer, in (1).

(3) The present disclosure provides a cathode, in which the first solid electrolyte has an average particle diameter (D₅₀) greater than an average particle diameter (D₅₀) of the second solid electrolyte, in (1) or (2).

(4) The present disclosure provides a cathode, in which the first solid electrolyte has an average particle diameter (D₅₀) ranging from 2.5 μm to 4.5 μm, in any one of (1) to (3).

(5) The present disclosure provides a cathode, in which a content of the cathode active material included in the first cathode active material layer ranges from 80 wt % to 90 wt %, based on a sum of weights of the cathode active material included and the first solid electrolyte in the first cathode active material layer, in any one of (1) to (4).

(6) The present disclosure provides a cathode, in which a content of the first solid electrolyte included in the first cathode active material layer ranges from 10 wt % to 30 wt %, based on a sum of weights of a cathode active material and the first cathode active material included in the first cathode active material layer, in any one of (1) to (5).

(7) The present disclosure provides a cathode, in which the content of the binder included in the first cathode active material layer ranges from 2 wt % to 3.5 wt % based on the total weight of the first cathode active material layer, in any one of (1) to (6).

(8) The present disclosure provides a cathode, in which an average particle diameter (D₅₀) of the second solid electrolyte ranges from 0.5 μm to 4.5 μm, in any one of (1) to (7).

(9) The present disclosure provides a cathode, in which a content of the cathode active material included in the second cathode active material layer ranges from 70 wt % to 80 wt %, based on a sum of weights of the cathode active material and the second solid electrolyte included in the second cathode active material layer, in any one of (1) to (8).

(10) The present disclosure provides a cathode, in which a content of the binder included in the second cathode active material layer ranges from 0.5 wt % to 2 wt % based on the total weight of the second cathode active material layer, in any one of (1) to (9).

(11) The present disclosure provides a cathode, in which the binder includes at least one selected from butadiene rubber (BR), styrene-butadiene rubber (SBR), styrene-butadiene-styrene block copolymer (SBS), nitrile-butadiene rubber (NBR), and hydrogenated nitrile-butadiene rubber (HNBR), in any one of (1) to (10).

(12) The present disclosure provides a cathode, in which the thickness ratio of the first cathode active material layer calculated through Equation 1 ranges from 0.2 to 0.5.

$$Thickness ratio of the first cathode active material layer = \frac{Thickness [ μ m ] of first cathode active layer}{Thickness [ μ m ] of first cathode active layer + Thickness [ μ m ] of second cathode active material layer} \qquad [ Equation 1 ]$$

(13) The present disclosure provides a cathode, in which the ratio of the thickness of the current collector to the whole thickness of the cathode ranges from 4 to 8, in any one of (1) to (12).

(14) The present disclosure provides an all-solid-state battery including the cathode according to (1), an anode, and a solid electrolyte layer.

(15) The present disclosure provides a method for manufacturing a cathode, which includes forming a cathode slurry stack by sequentially stacking a cathode current collector, first cathode active material slurry, second cathode active material slurry, and drying the cathode slurry stack, in which the first cathode active material slurry includes a first solid electrolyte, a cathode active material, and a binder, the second cathode active material slurry includes a second solid electrolyte, a cathode active material, and a binder, and a weight reference content of the binder included in the first cathode active material slurry is higher than a content of a binder included in the second cathode active material slurry.

(16) The present disclosure provides a method for manufacturing a cathode, in which the drying is performed at a temperature ranging from 70 °C to 110 °C, in (15).

(17) The present disclosure provides a method for manufacturing a cathode, in which the forming of the cathode slurry stack includes preparing each of the first cathode active material slurry and the second cathode active material slurry, and simultaneously applying the first cathode active material slurry and the second cathode active material slurry on the cathode current collector, in (15) or (16).

(18) The present disclosure provides a method for manufacturing a cathode, in which the forming of the cathode slurry stack includes preparing each of the first cathode active material slurry and the second cathode active material slurry, applying the first cathode active material slurry on the cathode current collector, and applying the second cathode active material slurry on the first crystalline solid electrolyte slurry, in (15) or (16).

(19) The present disclosure provides a method for manufacturing a cathode, in which the preparing of the slurry includes mixing a binder having a concentration ranging from 5.5 wt % to 8 wt % and being in a solution state in each of the first cathode active material and the second cathode active material slurry in (17).

### BRIEF DESCRIPTION OF THE DRAWINGS

The above and other objects, features and advantages of the present disclosure will be more apparent from the following detailed description taken in conjunction with the accompanying drawings:

FIG. 1 is a concept view illustrating the shape of a cathode according to the present disclosure; and

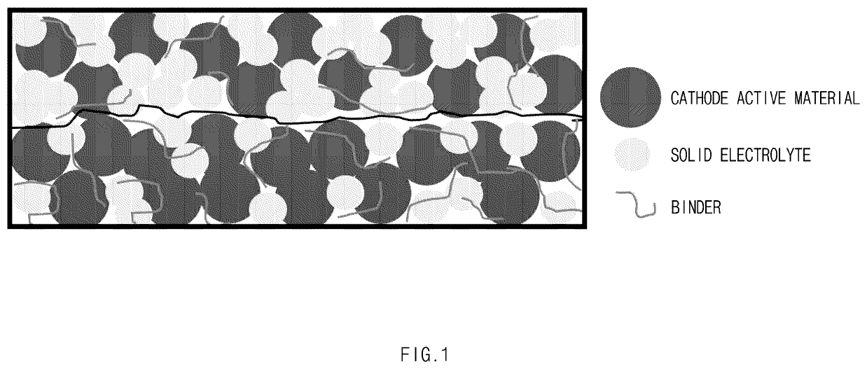

FIG. 2 is a graph illustrating a capacity retention as a function of the number of cycles of an all-solid-state battery using a cathode manufactured according to an embodiment of the present disclosure and a comparative example.

### DETAILED DESCRIPTION

Hereinafter, the present disclosure will be described in detail.

Terms or words used in the present specification and the claims should not be interpreted as commonly-used dictionary meanings, but be interpreted as to be relevant to the technical scope of the present disclosure based on the fact that the inventor may properly define the concept of the terms to explain the present disclosure in best ways.

### Cathode

The present disclosure provides a cathode including a cathode current collector, a first cathode active material layer, which is stacked on the cathode current collector and includes a first solid electrolyte, a cathode active material, and a binder, and a second cathode active material layer stacked on the first cathode active material layer and including a second solid electrolyte, a cathode active material, and a binder. In this case, a reference content by weight of the binder included in the first cathode active material layer is higher than the content of a binder included in the second cathode active material layer.

Hereinafter, the configuration of the cathode according to the present disclosure will be described in detail.

In embodiments, the cathode may include the cathode current collector which transfers an electron generated from the cathode active material to the outside, and transfers an electron introduced from the outside to the cathode active material during a charging process. The cathode current collector may include various materials without a particular limitation, as long as the materials are employed for the cathode current collector. For example, the materials for the cathode current collector may include stainless steel, copper, aluminum, nickel or titanium.

In embodiments, the cathode current collector has the thickness of at least 10 μm, at least 10.5 μm, at least 11 μm, at least 11.5 μm, at least 12 μm, at least 12.5 μm, at least 13 μm, or at least 13.5 μm, and may be at most 20 μm, at most 19.5 μm, at most 19 μm, at most 18.5 μm, at most 18 μm, at most 17.5 μm, at most 17 μm, or at most 16.5 μm. The energy density of the cathode may be more increased within the above range.

According to the present disclosure, each of the first cathode active material layer and the second cathode active material layer may include a cathode active material. The cathode active material may include various materials without the particular limitation, as long as the materials intercalate or deintercalate lithium ions and typically are employed for the all-solid-state battery. The cathode active material may be an oxide active material or a sulfide active material.

Preferably, the cathode active material may be an oxide active material, and more preferably an NCM-based active material.

In embodiments, the cathode includes the first cathode active material layer stacked on the cathode current collector. The first cathode active material layer may increase adhesive force between a cathode active material layer and the current collector of the cathode, and may improve the durability of the cathode. Accordingly, the content of the binder and the ratio of the cathode active material included in the first cathode active material layer may be set to be higher compared to those of the binder and the cathode active material included in the second cathode active material layer.

In other words, the content of the binder by weight included in the first cathode active material layer may be higher than that of the binder included in the second cathode active material layer. In addition, based on the total weight of the cathode active material and the solid electrolyte included in each of the first and second cathode active material layers, the content of the cathode active material included in the first cathode active material layer may be higher than that included in the second cathode active material layer.

In embodiments, the first solid electrolyte included in the first cathode active material layer may be an inorganic solid electrolyte such as a sulfide-based solid electrolyte, an oxide-based solid electrolyte, a halide-based solid electrolyte, or a solid polymer electrolyte. Preferably, the first solid electrolyte may be a sulfide-based solid electrolyte.

In embodiments, the sulfide-based solid electrolyte may be various general sulfide-based solid electrolytes without the particular limitation. Preferably, the sulfide-based solid electrolyte includes at least one selected from Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂SSiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which ‘m’ and ‘n’ is positive numbers; ‘Z’ is one of Ge, Zn, and Ga), Li₂S—GeS₂, Li₂S—SiS₂—Li₃PO₄, Li₂S—SiS₂—LiₓMO_{y} (in which ‘x’ and ‘y’ are positive numbers; Mis one among P, Si, Ge, B, Al, Ga, and In), and Li₁₀GeP₂S₁₂.

In embodiments, the oxide-based solid electrolyte may be various general oxide-based solid electrolytes without the particular limitation. Preferably, the oxide-based solid electrolyte includes at least one selected from Li_{1+x+y}AlₓTi₂₋ₓSi_{y}P_{3-y}O₁₂ (0<x<2, 0≤y<3), BaTiO₃, ⁻(PLZT) (0≤x<1, 0≤y<1), PB(Mg₃Nb_{2/3})O₃—PbTiO₃(PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃(0<x<2, 0<y<3), LiₓAl_{y}Ti_{z}(PO₄)₃ (0<x<2,0<y<1, 0<z<3), Li_{1+x+y}(Al, Ga)ₓ(Ti, Ge)₂₋ₓSi_{y}P_{3-y}O₁₂ (0≤x≤1, 0≤y≤1), LiₓLa_{y}TiO₃ (0<x<2, 0<y<3), Li₂O, LiOH, Li₂CO₃, LiAlO₂, Li₂O—Al₂O₃—SiO₂—P₂O₅—TiO₂—GeO₂, Li₃₊ₓLa₃M₂O₁₂ (M=Te, Nb, or Zr; 0≤x≤10), and Li₂La₃Zr₂₋ₓTaₓO₁₂ (0<x<2, LLZ-Ta).

In embodiments, the solid polymer electrolyte may be various general solid polymer electrodes without the particular limitation. Preferably, the solid polymer electrolyte includes at least one selected from polyethylene oxide, poly(diallyldimethylammonium) TFSI), Cu₃N, Li₃N, LiPON, Li₃PO₄·Li₂S·SiS₂, Li₂S·GeS₂·Ga₂S₃, Li₂O·₁₁Al₂O₃, Na₂O·₁₁Al₂O₃, (Na,Li)₁₊ₓTi₂₋ₓAlₓ(PO₄)₃ (0.1≤x≤0.9), Li₁₊ₓHf₂₋ₓAlₓ (PO₄)₃ (0.1≤x≤0.9), Na₃Zr₂Si₂PO₁₂, Li₃Zr₂Si₂PO₁₂, Na₅ZrP₃O₁₂, Na₅TiP₃O₁₂, Na₃Fe₂P₃O₁₂, NaqNbP₃O₁₂, Na-Silicates, Li_{0.3}La_{0.5}TiO₃, Na₅MSi₄O₁₂(′M′ is a rare-earth element such as Nd, Gd, or Dy), Li₅ZrP₃O₁₂, Li₅TiP₃O₁₂, Li₃Fe₂P₃O₁₂, Li₄NbP₃O₁₂, Li₁₊ₓ(M,Al,Ga)ₓ(Ge_{1-y}Ti_{y})₂₋ₓ(PO₄)₃ (x≤0.8; 0≤y≤1.0; ‘M’ is Nd, Sm, Eu, Gd, Tb, Dy, Ho, Er, Tm or Yb), Li_{1+x+y}QₓTi₂₋ₓSi_{y}P_{3-y}O₁₂ (0<x<0.4; 0<y≤0.6; ‘Q’ is Al or Ga), LiBaLa₂Ta₂O₁₂, Li₂La₃Zr₂O₁₂, Li₅La₃Nb₂O₁₂, Li₅La₃M₂O₁₂(‘M’ is Nb or, Ta), and Li₂₊ₓAₓLa₃₋ₓZr₂O₁₂ (0<x<3; ‘A’ is Zn).

In embodiments, the halide-based solid electrolyte may include an Li element, an M element (‘M’ is metal other than Li), and an X element (X is halogen). As ‘X’, for example, may be F, Cl, Br, and I. Especially, the halide-based solid electrolyte may appropriately include, at least one of Br or Cl as the ‘X’. In addition, the ‘M’ may be a metal element, such as Sc, Y, B, Al, Ga, and In.

In embodiments, the first solid electrolyte may have an average particle diameter (D₅₀) of at least 2.5 μm, at least 2.6 μm, at least 2.7 μm, at least 2.8 μm, at least 2.9 μm, or at least 3.0 μm, and may be at most 4.5 μm, at most 4.4 μm, at most 4.3 μm, at most 4.2 μm, at most 4.1 μm, or at most 4.0 μm. Within the range, the deterioration rate made during the charging and discharging process may be decreased. Accordingly, the mechanical strength of the first cathode active material layer may be improved.

In embodiments, the content of the cathode active material included in the first cathode active material layer may be at least 80 wt %, at least 80.5 wt %, at least 81 wt %, at least 81.5 wt %, at least 82 wt %, at least 82.5 wt %, or at least 83 wt %, and may be at most 90 wt %, at most 89.5 wt %, at most 89 wt %, at most 88.5 wt %, at most 88 wt %, at most 87.5 wt %, or at most 87 wt %, based on the sum of weights of the cathode active material and the first solid electrolyte included in the first cathode active material layer. Within the range, the binder coverage may be increased. Accordingly, the adhesive force of the cathode may be improved.

In embodiments, the content of the first solid electrolyte included in the first cathode active material layer may be at least 10 wt %, at least 11 wt %, at least 12 wt %, at least 13 wt %, at least 14 wt %, or at least 15 wt %, and may be at most 30 wt %, at most 29 wt %, at most 28 wt %, at most 27 wt %, at most 26 wt %, or at most 25 wt %, based on the sum of weights of the cathode active material and the first solid electrolyte included in the first cathode active material layer. Within the range, the binder coverage may be increased. Accordingly, the adhesive force of the cathode may be improved.

In embodiments, the content of the binder included in the first cathode active material layer may be at least 2 wt %, at least 2.05 wt %, at least 2.10 wt %, at least 2.15 wt %, at least 2.20 wt %, at least 2.25 wt %, or at least 2.30 wt %, and may be at most 3.50 wt %, at most 3.45 wt %, at most 3.40 wt %, at most 3.35 wt %, at most 3.30 wt %, at most 3.25 wt %, or at most 3.20 wt %, based on the total weight of the first solid electrolyte layer. Within the range, the adhesive force of the first cathode active material layer may be improved. Accordingly, the durability of the cathode may be further increased.

In embodiments, the coverage of the binder included in the first cathode active material layer may be at least 15 μm, at least 15.5 μm, at least 16 μm, at least 16.5 μm, at least 17 μm, at least 17.5 μm, at least 18 μm, at least 18.5 μm, at least 19 μm, at least 19.5 μm, or at least 20 μm, and may be at most 25 μm, at most 24.5 μm, at most 24 μm, at most 23.5 μm, at most 23 μm, at most 22.5 μm, at most 22 μm, at most 21.5 μm, at most 21 μm, or at most 20.5 μm. Within the range, the adhesive force of the first cathode active material layer may be excellently improved. The binder coverage is a value which quantitatively indicates a coating extent of the particle surface by the binder. The binder coverage may be calculated by dividing the volume of the binder, which is included in the first cathode active material layer, by the sum of the surface areas of solid materials such as the cathode active material and the solid electrolyte included in the first cathode active material.

In embodiments, the binder includes at least one selected from butadiene rubber (BR), styrene-butadiene rubber (SBR), styrene-butadiene-styrene block copolymer (SBS), nitrile-butadiene rubber (NBR), and hydrogenated nitrile-butadiene rubber (HNBR). Preferably, the binder may be BR.

When the binder includes BR, SBR, or SBS, the content of polar functional groups (—COOH-group, —OH-group, —OR-group) included in the binder may be at least 5 wt %, at least 5.5 wt %, at least 6 wt %, at least 6.5 wt %, at least 7 wt %, at least 7.5 wt %, at least 8 wt %, at least 8.5 wt %, at least 9 wt %, at least 9.5 wt %, or at least 10 wt %, and may be at most 20 wt %, at most 19.5 wt %, at most 19 wt %, at most 18.5 wt %, at most 18 wt %, at most 17.5 wt %, at most 17 wt %, at most 16.5 wt %, at most 16 wt %, at most 15.5 wt %, or at most 15 wt %. In addition, when the binder includes the NBR-based rubber, the content of acrylonitrile included in the binder may be at least 10 wt %, at least 11 wt %, at least 12 wt %, at least 13 wt %, at least 14 wt %, at least 15 wt %, at least 16 wt %, at least 17 wt %, or at least 18 wt %, and at most 28 wt %, at most 27 wt %, at most 26 wt %, at most 25 wt %, at most 24 wt %, at most 23 wt %, at most 22 wt %, at most 21 wt %, or at most 20 wt %.

According to the present disclosure, the cathode may include the second cathode active material layer stacked on the first cathode active material layer. The second cathode active material layer may have a surface in contact with the solid electrolyte layer, so as to increase ion conductivity and thereby improve the output of the battery.

According to the present disclosure, the cathode may include the first cathode active material layer to improve the adhesive force and the second cathode active material layer to improve a battery power characteristic to maximize the effects of the first cathode active material layer and the second cathode active material layer while minimizing the interface between the first cathode active material layer and the second cathode active material layer, thereby implementing the optimal performance.

According to the present disclosure, the second solid electrolyte included in the second cathode active material layer may include the same type material as that of the first solid electrolyte described above. The average particle diameter (D₅₀) of the first solid electrolyte may be at least 0.5 μm, at least 0.75 μm, at least 1 μm, at least 1.25 μm, at least 1.5 μm, at least 1.75 μm, or at least 2.0 μm, and at most 4.5 μm, at most 4.25 μm, at most 4 μm, at most 3.75 μm, at most 3.5 μm, at most 3.25 μm, or at most 3.0 μm. Within the range, the movement path of ions may be optimized. Accordingly, the ion conductivity may be increased. Accordingly, battery power may be improved.

In embodiments, the content of the cathode active material included in the second cathode active material layer may be at least 70 wt %, at least 70.5 wt %, at least 71 wt %, at least 71.5 wt %, at least 72 wt %, at least 72.5 wt %, or at least 73 wt %, and may be at most 80 wt %, at most 79.5 wt %, at most 79 wt %, at most 78.5 wt %, at most 78 wt %, at most 77.5 wt %, or at most 77 wt %, based on the sum of weights of the cathode active material and the second solid electrolyte included in the second cathode active material layer. Within the range, the binder coverage may be reduced, such that ion conductivity may be improved. Accordingly, the power characteristic may be improved.

In embodiments, the content of the second solid electrolyte included in the second cathode active material layer may be at least 10 wt %, at least 11 wt %, at least 12 wt %, at least 13 wt %, at least 14 wt %, or at least 15 wt %, and may be at most 30 wt %, at most 29 wt %, at most 28 wt %, at most 27 wt %, at most 26 wt %, or at most 25 wt %, based on the sum of weights of the cathode active material and the second solid electrolyte included in the second cathode active material layer. Within the range, the binder coverage may be reduced, such that ion conductivity may be improved. Accordingly, the power characteristic may be improved.

In embodiments, the content of the binder included in the second cathode active material layer may be at least 0.5 wt %, at least 0.55 wt %, at least 0.6 wt %, at least 0.65 wt %, at least 0.7 wt %, at least 0.75 wt %, or at least 0.8 wt %, and at most 2 wt %, at most 1.9 wt %, at most 1.8 wt %, at most 1.7 wt %, at most 1.6 wt %, at most 1.5 wt %, or at most 1.4 wt %, based on the total weight of the second cathode active material layer. Within the above range, the ionic conductivity of the second cathode active material layer may be improved. Accordingly, the power characteristic may be improved. In this case, the binder may be the same as the binder included in the first cathode active material layer.

In embodiments, the binder coverage included in the second cathode active material layer may be at least 5 μm, at least 5.5 μm, at least 6 μm, at least 6.5 μm, or at least 7 μm, and at most 10 μm, at most 9.5 μm, at most 9 μm, at most 8.5 μm, at most 8 μm, or at most 7.5 μm. Within the range, the ion conductivity of the second cathode active material layer may be significantly increased.

According to the present disclosure, an average particle diameter of the first solid electrolyte may be greater than an average particle diameter of the second solid electrolyte. In this case, the first cathode active material layer may improve the mechanical strength of the cathode and the second cathode active material layer may be increased the ion conductivity of the cathode. Accordingly, the mechanical strength and the power characteristics may be improved.

Each of the first cathode active material layer and the second cathode active material layer may additionally include a conductive material. The conductive material may include a typical material employed for the typical cathode without a particular limitation. Preferably, the conductive material may includes at least one selected from a carbon-based material, such as natural graphite, artificial graphite, carbon black, acetylene black, ketjen black, carbon fiber, and a carbon nano-tube; a metal-based material in the form of metal powders or metal fibers containing copper, nickel, aluminum, or silver; and a conductive polymer such as polyphenylene derivatives.

According to the present disclosure, the first cathode active material layer may have the thickness at least 25 μm, at least 26 μm, at least 27 μm, at least 28 μm, at least 29 μm, at least 30 μm, at least 31 μm, at least 32 μm, at least 33 μm, at least 34 μm, or at least 35 μm, and at most 65 μm, at most 64 μm, at most 63 μm, at most 62 μm, at most 61 μm, at most 60 μm, at most 59 μm, at most 58 μm, at most 57 μm, at most 56 μm, at most 55 μm, at most 54 μm, at most 53 μm, at most 52 μm, at most 51 μm, at most 50 μm, at most 49 μm, at most 48 μm, at most 47 μm, at most 46 μm, or at most 45 μm. Within the range, the power characteristic of the electrode may be more improved.

In addition, according to the present disclosure, the second cathode active material layer may have the thickness of at least 50 μm, at least 51 μm, at least 52 μm, at least 53 μm, at least 54 μm, at least 55 μm, at least 56 μm, at least 57 μm, at least 58 μm, at least 59 μm, or at least 60 μm, and at most 85 μm, at most 84 μm, at most 83 μm, at most 82 μm, at most 81 μm, at most 80 μm, at most 79 μm, at most 78 μm, at most 77 μm, at most 76 μm, at most 75 μm, at most 74 μm, at most 73 μm, at most 72 μm, at most 71 μm, or at most 70 μm. Within the above range, the energy density of the cathode may be more increased.

According to the present disclosure, in the cathode, a thickness ratio of the first cathode active material layer calculated through following Equation 1 may be at least 0.20, at least 0.22, at least 0.24, at least 0.26, at least 0.28, or at least 0.30, and at most 0.50, at most 0.48, at most 0.46, at most 0.44, at most 0.42, or at most 0.40.

$$Thickness ratio of the first cathode active material layer = \frac{Thickness [ μ m ] of first cathode active layer}{Thickness [ μ m ] of first cathode active layer + Thickness [ μ m ] of second cathode active material layer} \qquad [ Equation 1 ]$$

Within the range, the adhesive force of the first cathode active material layer may be excellently improved, and the power characteristic of the second cathode active material layer may be excellently improved, such that the cathode is optimally designed.

According to the present disclosure, the ratio of the thickness of the current collector to the whole thickness of the cathode may be at least 4.0, at least 4.1, at least 4.2, at least 4.3, at least 4.4, at least 4.5, at least 4.6, at least 4.7, at least 4.8, at least 4.9, or at least 5.0, and at most 8.0, at most 7.9, at most 7.8, at most 7.7, at most 7.6, at most 7.5, at most 7.4, at most 7.3, at most 7.2, at most 7.1, or at most 7.0. Within the above range, the functions intended through each layer may be effectively achieved.

### All-Solid-State Battery

The present disclosure may provide an all-solid-state battery including the cathode, the anode, and the solid electrolyte layer.

The anode and the solid electrolyte may include the material employed for the typical all-solid-state battery without a particular limitation.

### Method for Manufacturing Cathode

The present disclosure provides a method for manufacturing the cathode, which includes the steps for forming a cathode slurry stack by sequentially stacking first cathode active material slurry and second cathode active material slurry, and drying the cathode slurry stack. The first cathode active material slurry includes the first solid electrolyte, the cathode active material, and the binder, and the second cathode active material slurry includes the second solid electrolyte, the cathode active material, and the binder, in which the weight reference content of the binder included in the first cathode active material slurry is higher than the content of the binder included in the second cathode active material slurry.

Hereinafter, the method for manufacturing the cathode according to the present disclosure will be described in detail.

According to the method for manufacturing the cathode of the present disclosure, the cathode slurry stack is formed by stacking the first cathode active material slurry and the second cathode active material slurry and is integrally dried, thereby minimizing the resistance caused on the interface between double layers. The cathode manufactured through the method may be improved in ion conductivity and the power characteristic.

In addition, the method for manufacturing the cathode according to the present disclosure may be a method for manufacturing the above-described cathode. Accordingly, the cathode active material, the solid electrolyte, and the binder employed in the method for manufacturing the cathode may be employed as described above.

According to an embodiment of the present disclosure, in the method for manufacturing the cathode, the forming of the cathode slurry stack may include preparing the first cathode active material slurry and the second cathode active material slurry, and simultaneously applying the first cathode active material slurry and the second cathode active material slurry on the current collector. In this case, the first cathode active material slurry and the second cathode active material slurry may be closely applied in contact with each other, minimizing the interfacial resistance between the respective layers, and thereby reducing the resistance of the resulting cathode.

According to another embodiment of the present disclosure, in the method for manufacturing the cathode, the forming of the cathode slurry stack may include the steps for preparing each of the first cathode active material slurry and the second cathode active material slurry (or the slurry preparing step), applying the first cathode active material slurry on the cathode current collector, and applying the second cathode active material on the first cathode active material slurry. According to the present disclosure, when the cathode is prepared, the slurry may be applied through a wet-on-wet manner. Accordingly, the resistance made on a double-layer interface may be minimized.

The slurry preparing step may include mixing a binder in a solution state with each of the first cathode active material slurry and the second cathode active material slurry. In this case, the solid content concentration of each cathode active material slurry may be adjusted according to the amount of the binder solution mixed.

The solid content concentration of each cathode active material slurry may be at least 50 wt %, at least 51 wt %, at least 52 wt %, at least 53 wt %, at least 54 wt %, at least 55 wt %, at least 56 wt %, at least 57 wt %, at least 58 wt %, at least 59 wt %, or at least 60 wt %, and at most 70 wt %, at most 69 wt %, at most 68 wt %, at most 67 wt %, at most 66 wt %, at most 65 wt %, at most 64 wt %, at most 63 wt %, at most 62 wt %, at most 61 wt %, or at most 60 wt %. Within the above range, the stability of the slurry may be increased.

In this case, the concentration of the binder may be at least 5.5 wt %, at least 5.6 wt %, at least 5.7 wt %, at least 5.8 wt %, at least 5.9 wt %, or at least 6.0 wt %, and at most 8 wt %, at most 7.9 wt %, at most 7.8 wt %, at most 7.7 wt %, at most 7.6 wt %, at most 7.5 wt %, at most 7.4 wt %, at most 7.3 wt %, at most 7.2 wt %, at most 7.1 wt %, or at most 7.0 wt %. Within the range, the concentration each cathode active material slurry may be easily adjusted, as the binder solution is introduced.

The drying step may be performed at the temperature of at least 70 °C, at least 71 °C, at least 72 °C, at least 73 °C, at least 74 °C, at least 75 °C, at least 76 °C, at least 77 °C, at least 78 °C, at least 79 °C, or at least 80 °C, and at most 90 °C, at most 89 °C, at most 88 °C, at most 87 °C, at most 86 °C, at most 85 °C, at most 84 °C, at most 83 °C, at most 82 °C, at most 81 °C, or at most 80 °C. Within the above range, the first cathode active material and the second cathode active material may be effectively dried. Accordingly, layers may be closer to each other to reduce the interface resistance.

Hereinafter, although embodiments and an experimental example will be described in more detail to describe the present disclosure in detail, the present disclosure is not limited to the embodiments and the experimental examples. However, embodiments of the present disclosure may have various modifications, and the scope of the present disclosure is not limited to following embodiments. The embodiments of the present disclosure are provided to describe the present disclosure for those skilled in the art more completely.

### Embodiment 1

250 to 350 g of the NCM-based active material and 60 to 80 g of the sulfide-based solid electrolyte having a particle diameter of 2.5 to 4.5 μm and serving as the first solid electrolyte were dry mixed through a P/D mixer. Then, a carbon-based conductive material, a polyethylene-based dispersant, and a butyrate-based solvent were additionally introduced and the result was mixed again. A solution containing 6 to 7 wt % of BR—COOH (butadiene rubber-COOH) serving as a binder was introduced in amount ranging from 100 g to 130 g, and the result was mixed, thereby preparing the first cathode active material slurry. Separately, the second cathode active material slurry was prepared in the same manner as the manner for preparing the first cathode active material slurry, except that 200 to 300 g of the NCM-based active material, and 80 to 100 g of the sulfide-based solid electrolyte having a particle diameter of 0.5 to 4.5 μm and serving as the second solid electrolyte were employed, which were different from the first cathode active material slurry. Thereafter, after sequentially applying the first cathode active material slurry and the second cathode active material slurry on an AL current collector, and the result was dried at 90 °C, thereby manufacturing the cathode.

In this case, the content of the binder was calculated to 2.5 wt % or 1 wt %, based on the total weight of the first cathode active material layer or the second cathode active material layer.

### Embodiment 2

When compared to Embodiment 1, the cathode was manufactured through the manner the same as that of Embodiment 1, except that an amount of binder introduced was adjusted such that the content of the binder was calculated to 2 wt % or 1.5 wt %, based on the total weight of the first cathode active material layer or the second cathode active material layer.

### Comparative Example 1

When compared to Embodiment 1, the cathode was manufactured through the manner the same as that of Embodiment 1, except that 230 g to 330 g of a cathode active material and 70 g to 90 g of first solid electrolyte were employed for the first cathode active material slurry, and 230 g to 330 g of the cathode active material was employed for the second cathode active material slurry, and an amount of binder introduced was adjusted to be calculated to 1.75 wt % and 1.75 wt %, based on the total weight of the first cathode active material layer or the second cathode active material layer.

### Comparative Example 2

When compared to Comparative example 1, the cathode was manufactured through the manner the same as that of Comparative example 1, except that an amount of binder introduced was adjusted such that the content of the binder was calculated to be 2 wt % and 2 wt %, based on the total weight of the first cathode active material layer or the second cathode active material layer.

### Comparative Example 3

When compared to Comparative example 1, the cathode was manufactured through the manner the same as that of Comparative example 1, except that 200 g to 300 g of a cathode active material and 80 g to 100 g of first solid electrolyte were employed for the first cathode active material slurry, and 200 g to 300 g of the cathode active material was employed for the second cathode active material slurry, and an amount of binder introduced was adjusted to be calculated to 2 wt % and 2 wt %, based on the total weight of the first cathode active material layer or the second cathode active material layer.

### Comparative Example 4

When compared to Comparative example 1, the cathode was manufactured through the manner the same as that of Comparative example 1, except that 200 g to 300 g of a cathode active material and 80 g to 100 g of first solid electrolyte were employed for the first cathode active material slurry, and 250 g to 350 g of the cathode active material was employed for the second cathode active material slurry, and an amount of binder introduced was adjusted to be calculated to 2 wt % and 2 wt %, based on the total weight of the first cathode active material layer or the second cathode active material layer.

The content of the binder included in each of the first cathode active material layer and the second cathode active material layer, the weight ratio between the cathode active material and the solid electrolyte, and the content of the binder included in the cathode active material layer in the cathodes manufactured according to the Embodiments and the Comparative examples, were summarized as in Table 1.

TABLE 1

| | First cathode active | | Second cathode active | | |
|---|---|---|---|---|---|
| | material layer | | material layer | | |
| | | Active | | Active | Binder |
| | Binder | material | Binder | material | wt % in |
| | wt % | electrolyte | wt % | electrolyte | electrode |
| Embodiment 1 | 2.5 | 85:15 | 1 | 75:25 | 1.75 |
| Embodiment 2 | 2 | 85:15 | 1.5 | 75:25 | 1.75 |
| Comparative | 1.75 | 80:20 | 1.75 | 80:20 | 1.75 |
| example 1 | | | | | |
| Comparative | 2 | 80:20 | 2 | 80:20 | 2 |
| example 2 | | | | | |
| Comparative | 2 | 75:25 | 2 | 75:25 | 2 |
| example 3 | | | | | |
| Comparative | 2 | 75:25 | 2 | 85:15 | 2 |
| example 4 | | | | | |

### Experimental Example 1: Evaluation for Adhesive Force and Resistance Characteristic of Cathode

To evaluate the adhesive force and the resistance characteristic of the cathodes manufactured in the Embodiments and the comparative examples, the adhesive force [gf/mm] and DC-IR [Ω] were measured through the following measuring manner, and the measurement result was summarized through Table 2.

### [Measurement Manner]

Adhesive force [gf/mm]: A 180? peel strength meter was employed, a cathode sample having the size of 25 mm×150 mm was prepared, and the half of the cathode sample was attached to slice glass (25 mm×75 mm) attached to a double-side tape. The cathode was peeled at the rate of 30 mm/min such that the force in the 20 to 40 mm section was measured. The measurement result was divided by the width of the cathode sample to calculate the adhesive force on average.

DC-IR [Ω]: A full-cell was manufactured by employing the cathode and activated. Then, the full-cell was charged at 0.33 C, and discharged at 50% of SOC for 10 seconds, thereby measuring the difference between the a rest voltage and the final discharge voltage. The difference was applied to the formula of ‘V=IR’ together with the current density to calculate the internal resistance value.

TABLE 2

| | Adhesive force | |
|---|---|---|
| | [gf/mm] | DC-IR[Ω] |
| Embodiment 1 | 0.18 | 10.2 |
| Embodiment 2 | 0.17 | 9.3 |
| Comparative | 0.15 | 10.7 |
| example 1 | | |
| Comparative | 0.23 | 13.2 |
| example 2 | | |
| Comparative | 0.14 | 12.5 |
| example 3 | | |
| Comparative | 0.11 | 12.8 |
| example 4 | | |

It may be recognized that the cathode manufactured according to an embodiment of the present disclosure exhibited higher adhesive force and higher internal resistance, when compared to the cathode according to Comparative examples 1, 3, and 4.

Accordingly, the cathode according to the present disclosure exhibited higher adhesive force and lower resistance, such that a current of the all-solid-state battery including the cathode may smoothly flow, thereby improving the energy efficiency, and improving the power characteristic.

### Experimental Example 2 Evaluation for Performance of all-Solid-State Battery

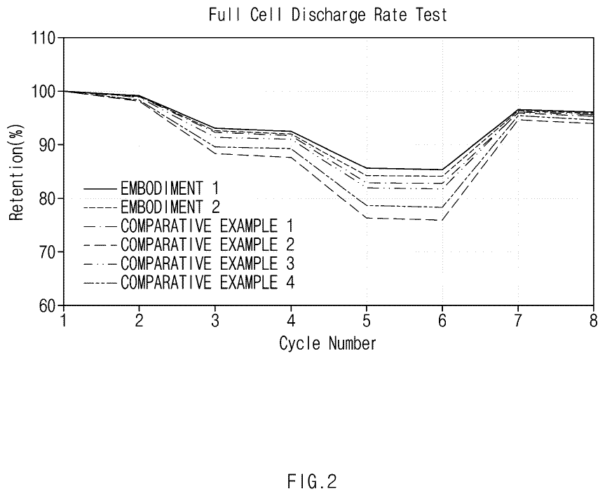

After the cathodes manufactured according to the embodiments and the comparative examples, the sulfide-based solid electrolyte, the anode including the Ni/Cu substrate, and the Si/C-based anode active material were sequentially stacked and pressed at higher pressure, thereby manufacturing the all-solid-state battery. In addition, under the normal temperature, the charging condition was set to 0.2 C, and the discharging condition was changed in order of 0.2C-0.33C-0.5C-0.2C. Then, the capacity retention the total 8 charging/discharging cycles were shown in the form of graph as illustrated in FIG. 2.

It may be recognized from FIG. 2 that the capacity retention of the all-solid-state battery including the cathodes manufactured according to an embodiment of the present disclosure exhibited higher capacity retention than the capacity retention of the all-solid-state battery including the cathodes manufactured according to the comparative examples. In addition, the all-solid-state batteries including the cathodes according to the embodiments exhibited higher than the all-solid-state batteries including the cathodes according to the comparative examples in terms of resilience and stability after high rate discharging.

It may be recognized from the above-described result that the cathode according to the present disclosure exhibited higher adhesive force and lower resistance characteristic, such that the active materials strongly made contact with the current collector, and the contact was uniformly maintained. In addition, the electrons and the ions were smoothly transmitted, due to the lower internal resistance of the cathode. Accordingly, the all-solid-state battery including the cathode according to the present disclosure may maintain the stabler electrode structure during charging/discharging, thereby improving the power characteristic.

According to the present disclosure, the cathode may exhibit the higher adhesive force and the lower resistance characteristic. Accordingly, the active material may strongly make contact with the current collector and the contact may be uniformly maintained. In addition, the cathode has the lower internal resistance to smoothly transmit the electrons and the ions. Accordingly, the all-solid-state battery including the cathode according to the present disclosure may stably maintain the electrode structure during the charging/discharging process, thereby improving the power characteristic.

In addition, according to the present disclosure, in the method for manufacturing the cathode, the resistances of the first cathode active material layer and the second cathode active material layer included in the cathode may be minimized. Accordingly, the cathode prepared may exhibit the higher adhesive force and the lower resistance characteristic.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A cathode comprising:
a cathode current collector,
a first cathode active material layer stacked on the cathode current collector, and including a first solid electrolyte, a cathode active material, and a binder; and
a second cathode active material layer stacked on the first cathode active material layer, and including a second solid electrolyte, a cathode active material, and a binder,
wherein a weight reference content of a binder included in the first cathode active material layer is higher than a content of a binder included in the second cathode active material layer.

2. The cathode of claim 1, wherein a content of the cathode active material included in the first cathode active material layer is higher than a content of the cathode active material included in the second cathode active material layer, based on the sum of weights of the cathode active material and the solid electrolyte included in each of the first cathode active material layer and the second cathode active material layer.

3. The cathode of claim 1, wherein the first solid electrolyte has an average particle diameter (D₅₀) greater than an average particle diameter (D₅₀) of the second solid electrolyte.

4. The cathode of claim 1, wherein the first solid electrolyte has an average particle diameter (D₅₀) ranging from 2.5 μm to 4.5 μm.

5. The cathode of claim 1, wherein a content of the cathode active material included in the first cathode active material layer ranges from 80 wt % to 90 wt %, based on a sum of weights of the cathode active material and the first solid electrolyte included in the first cathode active material layer.

6. The cathode of claim 1, wherein a content of the first solid electrolyte included in the first cathode active material layer ranges from 10 wt % to 30 wt %, based on a sum of weights of the first cathode active material included in the first cathode active material layer and the first solid electrolyte

7. The cathode of claim 1, wherein a content of the binder included in the first cathode active material layer ranges from 2 wt % to 3.5 wt %, based on the total weight of the first cathode active material layer.

8. The cathode of claim 1, wherein the second solid electrolyte has an average particle diameter (D₅₀) ranging from 0.5 μm to 4.5 μm.

9. The cathode of claim 1, wherein a content of the cathode active material included in the second cathode active material layer ranges from 70 wt % to 80 wt %, based on a sum of weights of the cathode active material and the second solid electrolyte included in the second cathode active material layer.

10. The cathode of claim 1, wherein a content of the binder included in the second cathode active material layer ranges from 0.5 wt % to 2 wt % based on the total weight of the second cathode active material layer.

11. The cathode of claim 1, wherein the binder includes:
at least one selected from butadiene rubber (BR), styrene-butadiene rubber (SBR), styrene-butadiene-styrene block copolymer (SBS), nitrile-butadiene rubber (NBR), and hydrogenated nitrile-butadiene rubber (HNBR).

12. The cathode of claim 1, wherein a thickness ratio of the first cathode active material layer calculated through following Equation 1 ranges from 0.2 to 0.5,
$$Thickness ratio of the first cathode active material layer = \frac{Thickness [ μ m ] of first cathode active layer}{Thickness [ μ m ] of first cathode active layer + Thickness [ μ m ] of second cathode active material layer} \qquad [ Equation 1 ]$$

13. The cathode of claim 1, wherein a ratio of a thickness of the current collector to a whole thickness of the cathode ranges from 4 to 8.

14. An all-solid-state battery comprising:
a cathode according to claim 1;
an anode; and
a solid electrolyte layer.

15. A method for manufacturing a cathode comprising:
forming a cathode slurry stack by sequentially stacking a cathode current collector, first cathode active material slurry, second cathode active material slurry; and
drying the cathode slurry stack,
wherein the first cathode active material slurry includes;
a first solid electrolyte, a cathode active material, and a binder,
wherein the second cathode active material slurry includes:
a second solid electrolyte, a cathode active material, and a binder, and
wherein a weight reference content of the binder included in the first cathode active material slurry is higher than a content of a binder included in the second cathode active material slurry.

16. The method of claim 15, wherein the drying is performed at a temperature ranging from 70 °C to 110 °C.

17. The method of claim 15, wherein the forming of the cathode slurry stack includes:
preparing each of the first cathode active material slurry and the second cathode active material slurry (slurry preparing); and
simultaneously applying the first cathode active material slurry and the second cathode active material slurry on the cathode current collector.

18. The method of claim 15, wherein the forming of the cathode slurry stack includes:
preparing each of the first cathode active material slurry and the second cathode active material slurry (slurry preparing);
applying the first cathode active material slurry on the cathode current collector; and
applying the second cathode active material slurry on the first cathode active material slurry.

19. The method of claim 17, wherein the slurry preparing includes:
mixing a binder having a concentration ranging from 5.5 wt % to 8 wt % and being in a solution state with each of the first cathode active material slurry and the second cathode active material slurry.
